(19) United States
(12) Patent Application Publication
(10) Pub. No.: US 2019/0235489 A1
(43) Pub. Date: Aug. 1, 2019

(54) SYSTEM AND METHOD FOR AUTONOMOUS REMOTE DRONE CONTROL

(71) Applicant: Walmart Apollo, LLC, Bentonville, AR (US)

(72) Inventors: Robert CANTRELL, Herndon, VA (US); Donald R. HIGH, Noel, MO (US); John J. O'BRIEN, Farmington, AR (US)

(73) Assignee: Walmart Apollo, LLC, Bentonville, AR (US)

(21) Appl. No.: 16/264,225

(22) Filed: Jan. 31, 2019

Related U.S. Application Data
(60) Provisional application No. 62/624,743, filed on Jan. 31, 2018.

(51) Int. Cl. G05D 1/00; G05D 1/10

(52) U.S. Cl. CPC G05D 1/0027; B64C 39/024; G05D 1/0088; G05D 1/101

(57) ABSTRACT

Methods and systems for establishing a daisy-chain connection with autonomous remote pilots are provided. An example method can include: under control of a computing device configured with executable instructions: generating a mission instruction for a drone to navigate from an original location to a destination along the flight route; instructing the drone with the mission instruction to navigate to the destination; generating, based on a pre-defined criteria, a first verification code based on the mission instruction; broadcasting the first verification code with the mission instruction to a plurality of remote pilots; selecting a first pilot from the plurality of the remote pilots; verifying the first verification code provided by the first pilot to authorize the first pilot to monitor, control, or backup the drone along the flight route; and generating a second verification code based on the mission instruction.

### CROSS-REFERENCE TO RELATED APPLICATION

This application claims the benefit of U.S. Provisional Patent Application No. 62/624,743, filed Jan. 31, 2018, which is incorporated by reference in its entirety.

### TECHNICAL FIELD

The present disclosure relates to autonomous remote pilot control system, and more specifically to system and method for autonomous remote pilots to command, control, and backup an autonomous vehicle system.

### BACKGROUND

Autonomous vehicles including aerial vehicles such as unmanned aerial vehicles (UAVs) (e.g. drones) can be used for performing surveillance, reconnaissance, and exploration tasks for military and civilian applications. Drones are generally aerial vehicles that operate without a human pilot aboard. The use of UAVs or drones for package delivery has become more prevalent in society. Achieving Return-on-Investment (ROI) on drone package delivery services requires keeping operating costs low. However, current Federal Aviation Administration (FAA) rules require that a drone is piloted by a person who is in sight of the drone. The FAA requirements to keep human pilots in control of drones or on standby to take control of the drone involve costs for services of those pilots and their administrative support.

In addition, the FAA currently requires daisy-chaining visual observers for beyond visual line of sight (BVLOS) package delivery missions and visual observers must be able to take over drone flights as pilots. This requires the missions for commercial package delivery to be short enough for the pilot at the launch site to maintain control of the drone throughout or involve an expensive string of pilots. Both scenarios are uneconomical and impractical since it would require more effort to set up and execute the delivery by a drone than to simply deliver the product by conventional means. Therefore, there is a need for a system with autonomous remote pilots to maintain an autonomous visual line of sight (VLOS) drone package delivery system.

### SUMMARY

An example computer-implemented method of performing concepts disclosed herein can include: generating a mission instruction for a drone to navigate from an original location to a destination along the flight route; instructing the drone with the mission instruction to navigate to the destination; generating, based on a pre-defined criteria, a first verification code based on the mission instruction; broadcasting the first verification code with the mission instruction to a plurality of remote pilots; selecting a first pilot from the plurality of the remote pilots; verifying the first verification code provided by the first pilot to authorize the first pilot to monitor, control, or backup the drone along the flight route; and generating a second verification code based on the mission instruction.

An example system configured to establish a daisy-chain connection with a plurality of remote pilots according to the concepts and principles disclosed herein can include a plurality of remote autonomous pilots; at least one computer processor; and a non-transitory computer-readable storage medium having instructions stored which, when executed by the processor, cause the processor to perform operations comprising: generating a mission instruction for a drone to navigate from an original location to a destination along the flight route; instructing the drone with the mission instruction to navigate to the destination; generating, based on a pre-defined criteria, a first verification code based on the mission instruction; broadcasting the first verification code with the mission instruction to a plurality of the remote pilots; selecting a first pilot from the plurality of the remote pilots; verifying the first verification code provided by the first pilot to authorize the first pilot to monitor, control, or backup the drone along the flight route; and generating a second verification code based on the mission instruction.

An example non-transitory computer-readable storage medium configured as disclosed herein can have instructions stored which, when executed by a computing device, cause the computing device to perform operations including: generating a mission instruction for a drone to navigate from an original location to a destination along the flight route; instructing the drone with the mission instruction to navigate to the destination; generating, based on a pre-defined criteria, a first verification code based on the mission instruction; broadcasting the first verification code with the mission instruction to a plurality of remote pilots; selecting a first pilot from the plurality of the remote pilots; verifying the first verification code provided by the first pilot to authorize the first pilot to monitor, control, or backup the drone along the flight route; and generating a second verification code based on the mission instruction.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Example embodiments of this disclosure are illustrated by way of an example and not limited in the figures of the accompanying drawings, in which like references indicate similar elements and in which:

FIG. 1 is a block diagram illustrating an example environment in which some example embodiments may be implemented;

FIG. 2 is a flowchart diagram illustrating an example process for establishing a daisy-chain connection with autonomous remote pilots in accordance with some example embodiments; and

FIG. 3 illustrates an exemplary workflow associated with blockchain based on interactions between various computing devices in accordance with some example embodiments;

FIG. 4 illustrates an example airborne in accordance with some example embodiments;

FIG. 5 is a diagram illustrating autonomous command and control in accordance with some example embodiments;

FIG. 6 is a diagram illustrating manual command and control in accordance with some example embodiments; and

FIG. 7 is a block diagram of an example computer system in which some example embodiments may be implemented.

It is to be understood that both the foregoing general description and the following detailed description are example and explanatory and are intended to provide further explanations of the invention as claimed only and are, therefore, not intended to necessarily limit the scope of the disclosure.

### DETAILED DESCRIPTION

Various example embodiments of the present disclosure will be described in detail below with reference to the accompanying drawings. Throughout the specification, like reference numerals denote like elements having the same or similar functions. While specific implementations and example embodiments are described, it should be understood that this is done for illustration purposes only. Other components and configurations may be used without parting from the spirit and scope of the disclosure, and can be implemented in combinations of the variations provided. These variations shall be described herein as the various embodiments are set forth.

Systems, methods, and computer-readable storage media provided in this disclosure are capable of providing autonomous remote pilots to command, control, and backup an autonomous vehicle (e.g., drone) and establishing a daisy-chain connection with a plurality of remote pilots to provide a visual line of sight along a drone flight route. The term “daisy chain,” as used herein, is referred to point to point connections among a plurality of remote pilots to establish a visual line of sight. Each of the remote pilots may operate or is controlled to operate as a visual observer along a visual line of sight. The term “customer,” as used herein, is broadly referred to people who request a particular service associated to a drone flight mission associated with specific operations.

In the present disclosure, the system extends operations of the drone beyond a pilot's vision by employing autonomous remote pilots which can take over the operation of the drone when needed or if required. The system involves developing autonomous remote pilots as a backup system to monitor the drone such that the drone can navigate autonomously and safely to a destination. The remote backup system may be set up with the autonomous remote pilots to take over piloting of the aircraft like a human pilot. The remote pilots may be autonomous. The backup pilots may be arrayed as a daisy chain along the flight path of the drone so that the system maintains autonomous VLOS. In addition, remote pilots may take control when the onboard drone systems fail, which may be another backup element added to a feature of the drone management system.

In some example embodiments, additional redundancy may be established by having more than one remote pilot available for a drone, which may also improve the efficiency of the drone flight mission. Groups of remote pilots may be provided and may be set along air rails so the no drone is BVLOS of an autonomous remote pilot.

In some example embodiments, remote pilots may also be established on airborne platforms and other drones to cover a large swath of area so that a backup is always available. A computing system may provide the backup pilot functionality and may not be subject to human limitations on being able to see drones. The computing system may receive real-time information to make observing, orienting on, deciding, and acting on a problem faster than simply relying on the drones themselves. The computing system may offer a benefit of redundancy for complete and multiple autonomous control system. The computing system may be shown to be technologically and statistically safer with a remote pilot stationed elsewhere than having a human pilot backup.

In some example embodiments, human intervention may be possible or the computer system may hand off the drones to a human pilot if there is a scenario that can be better handled by a human pilot.

In some example embodiments, the remote pilot may be continuously updated as to the location, vector, velocity, and attitude of one or more drones under its watch so that it can avoid a lag time between the need to take control and actually taking control. The need for a human pilot on site may be eliminated by having an autonomous control set handle the function of the backup pilot. The autonomous control set may operate as a remote pilot or visual observer with the added benefit of enhanced situational awareness from sensors incorporated in the drone and the ability to be logged in to the computing system of the drone. The lag between a drone problem and a human pilot getting oriented at the controls may be eliminated because the remote pilot can take actions instantly or near instantly. Remote pilot can handle multiple drones without degrading the system.

In the present disclosure, the autonomous remote control system may be less subject to human error since potential contingencies may be considered and the corresponding solution may be programmed in advance. The autonomous remote pilot control system may simulate drone takeovers by continuously calculating the action up to a trigger point when it actually does take over, e.g., computer equivalent of situational awareness on the highway. For example, if you know your left lane is clear at a given moment, you can take a left-hand evasive maneuver without having to look first. The remote pilot has the mission to bring a UAV/drone flight to a safe conclusion, but does not take over for the original mission.

In some example embodiments, the remote pilot also may be a security backup by navigating as the computer equivalent of a co-pilot, monitoring that everything the actual piloting system is seeing and doing is consistent with the intended mission. Therefore, a remote pilot may operate as an equivalent of a visual observer (VO). The remote pilot may be configured to implement multiple functions if it must take over flight, to get the drone to land safely at a nearby control point or to assist the drone in making the best landing possible when that a landing spot cannot be reached.

In some example embodiments, remote pilots may be separated from human control or contact and may be alerted if a physical contact is made to include air horn alarm. The remote pilots may be the primary system of flying the drones and onboard autonomy is the backup. This may allow for stripped down, super-inexpensive drones where autonomy is primarily oriented on making a safe landing if systems fail. The system may provide an expertise supplement to have the remote pilot to handle flying to the extent that a human operator is no longer needed to guide the drone through the mission. Thus, there is no need to hire a skilled pilot.

The system may exceed FAA rules or requirements regarding VLOS. The autonomous VLOS for the remote pilot system is not limited to the human eye, and may have longer visibility or in more adverse conditions.

In some example embodiments, more than one remote pilot system may be used on a route so that the remote pilots also have redundancies.

In some example embodiments, elements may be included on the drone to make the system highly visible to the computer's eyes, such as invisible light spectrum, heat, noise, reflection, laser links, transponders, and radar signature elements.

The autonomous remote pilot station may include human control levers or has a plug in so that human controls can operate the system. The controllability of the autonomous remote pilot may enhance training the system by having an expert human pilot handle simulated emergencies. The remote pilot control system may be an adapted system that can detect its operations based on feedbacks from the remote pilots. For example, the remote pilot may prioritize on using onboard sensors that work on remote detection, such as distance observation of trajectory and attitude. Thus, the distance observation of trajectory and attitude detected by the remote pilot may indicate that a given onboard sensor on the remote pilot is still working. The remote pilot may essentially be the controller of an onboard drone but set off-board and linked to take over flight. The remote pilot may rely on the same sensor output as the drone and use remote observed flight signatures as the backup.

The remote pilot control system may observe a tracking beacon so that the system may be landed at a safe site nearby, which may be based on LOS viewing in addition to other means.

In the present disclosure, autonomous VLOS may be established by having a laser based detection system. As long as the laser is tracking the drone, it is “seen,” noting that when the laser cannot see the drone, a person would not be able to see the drone. For example, in sudden fog, the computer system may have ways to “see” through the fog that a human pilot would not have or that would demand supplementary sensors geared to the human condition.

In some example embodiments, two or more laser sensors may provide a parallel track on the aircraft and may become a way for the autonomous remote pilot system to detect attitude, direction, and velocity of the aircraft from a distance.

In some example embodiments, a hotspot system on the drone may provide a heat signature in emergency situations so that the drone may be seen when obstructed by such conditions as a sudden fog bank. Heat signatures may be paired so that there are two heat signatures to detect. There may be temperature differences between the hotspots which makes it easier to detect orientation. Such a system may be one way to see through fog.

In some example embodiments, the remote pilot system may use blockchain handoffs or other encryption to prevent outside entities from remotely taking over a drone.

In some example embodiments, the remote pilot may control ground operations such as autonomous movements of drones from storage to servicing, loading, launching, and pre-flight and post-launch handoff to autonomy. In some example embodiments,

In some example embodiments, the remote pilots may also interface with indoor store operations systems to merge the movement of products with the availability and movement of drones to ensure safety backup.

In some example embodiments, the remote pilot control system may be applied to drones may fly in yards or fields to conduct specific operations associated with agriculture activities, medical supports, etc., where the same FAA rules may still apply.

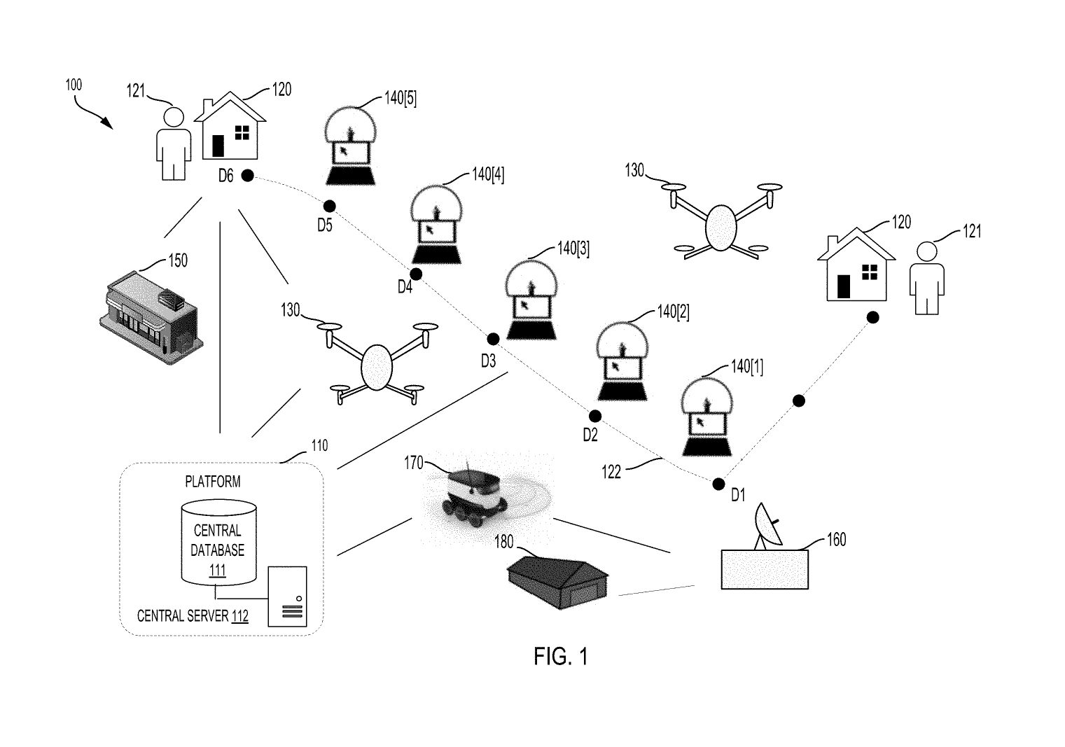

FIG. 1 is a block diagram illustrating an example environment 100 in which some example embodiments may be implemented. The example environment 100 generally includes one or more of platform 110, destination 120, customer 121, drone 130, a plurality of autonomous remote pilots 140, merchant's physical store 150, ground station 160, AGVs 170, and pickup site 180. FIG. 1 illustrates an autonomous command and control daisy chain for autonomous visual line of sight which may include a plurality of autonomous remote pilots 140[1]-[N], where N is a positive integer greater than one. In some example embodiments, drone flight route 122 may include a plurality of virtual nodes D[1]-D[N] defined therein, where N is a positive integer greater than one. For example, the virtual nodes D[1] and D[N] may be an original location and a package destination, respectively.

A plurality of remote autonomous pilots 140[1]-140[N] may be established along the drone flight route 122 and transfer the pilot control operations at the virtual nodes. Each remote pilot 140 may be registered in the system with a unique identification number or its device address. In some example embodiments, the autonomous remote pilot system may use standard encryption techniques and/or security protocols (e.g., pre-defined criteria), such as blockchain handoffs to prevent devices not in the system from remotely taking over a drone. In one example embodiment, the system may transfer control operations from remote pilot 140[2] to an autonomous drone 130 temporarily and then to remote pilot 140[3].

In some example embodiments, blockchain may also be used to dynamically record the important mission instructions and drone parameters associated with the drone delivery in real time. The blockchain may be used to issue an authentication and provide a hash code to the autonomous remote pilot to transfer a pilot control operation. The system may also provide authentication and a token to the authorized pilot. The system may control the pilot to pilot communication and facilitate the control transfer from pilot to pilot. In some embodiments, the system is configured to facilitate the communication and control transfer between remote pilots along the daisy chain until the drone 130 safely arrives at the destination 120 or node D6, as shown in FIG. 1. For example, the system may control a first pilot 140[1] to a second pilot 140[2] communication and facilitate the control transfer from the first pilot 140[1] to the second pilot 140[2], along the daisy chain until the drone 130 safely arrives at the destination 120 or node D6, as shown in FIG. 1.

The platform 110 may be a network-accessible computing platform and may be implemented as a computing infrastructure of one or more servers and databases including processors, memory (data storage), software, data access interface, and other components that are accessible via a mesh network and/or other wireless or wired networks. One or more servers, shown and referred to as central server 112 for simplicity, and one or more databases, shown and referred to as a central database 111 herein for simplicity. These servers may include one or more processors and memory which may be utilized to operate a drone management system.

The UAV or drone 130 may include a communication system, which allows the drone 130 to communicate with computing devices or processors in the computing environment 100 for a flight mission from base or ground station 160 to drone destination 120, such as a package delivery destination. The communication system may utilize cellular, radio frequency, near field communication, infrared, Bluetooth, Wi-Fi, satellite, or any other means for communication. The drone 130 also includes one or more visual sensors, proximity sensors, and other types of sensors. These visual sensors and proximity sensors may be placed on one or more surfaces of the drones. The drone may also include GPS and one or more processors, which may determine positioning information for drones and conduct specific functions or data analysis.

In the example computing environment 100, a mesh network (not shown) may include satellite-based navigation system or a terrestrial wireless network, Wi-Fi, and other type of wired or wireless networks to facilitate communications between the various networks devices associated with example computing environment 100. In some example embodiments, the central server 112 or other computing devices on the platform 110 may communicate, via the network, with drones 130, remote pilots 140, ground station 160 and AGV 170, and facilitate the drones to complete missions, such as for delivering one or more products or conduct specific operations, etc.

Ground station 160 may coordinate a drone flight mission by one or more drones 130 and AGVs 170. The ground station 160 may include a local server and a local database with one or more processors, a communication system including a receiver and a transmitter. For example, the ground station 160 may receive location information from the drone 130 and AGVs 170 via a Global Positioning System (GPS), local positioning, mobile phone tracking, or other means. The ground station 160 may also receive drone mission information from a drone management service, including mission details like a destination, origination location, and special instructions associated with the drone flight mission. For example, the ground station 160 may be nearby a merchant's physical store, store inventory, or a drone delivery management center where the drone carries the product for delivery along the flight route (e.g., drone flight route 122).

Customer 121 may create, via central server 112 and network, an account with platform 110 by creating a customer profile to store personal information and credentials of customer in central database 111. Each account profile may be configured to store data related to existing customer including customer's username, email address, password, phone number, customer's rating, drone delivery information, delivery (residential) address, payment transaction accounts, purchasing preference, search history, order history, information, other relevant demographic or analytical data, third parties including family members, friends, or neighbors, etc. The customer 121 may send a request for a drone delivery or other operations to the platform 110 to generate drone flight information and mission instruction for conducting specific operations, such as delivering a package to a delivery address, conduct a road or field investigation, etc. The platform 110 may update related data associated with the customer account profile and generate corresponding mission instructions for the drone route or other specific operations. In one example, a mission instruction for a drone delivery may include drone delivery destination, nearby pickup site information, delivery preference, drone delivery pickup timeslots, and other type of information related to drone delivery. The mission instructions for the related drone delivery may include package original location, package destination, package weight, package capacity, operational parameters of the drone, flight route, weather condition, and special instructions for handling of the package, etc. The operational parameters of the drone may comprise GPS information, flight heights, flight speeds, flight route, package weight, package capacity, battery information, direction, fuel level, air speed, etc. A flight route of the drone may be drone flight route 122 in the mission instruction.

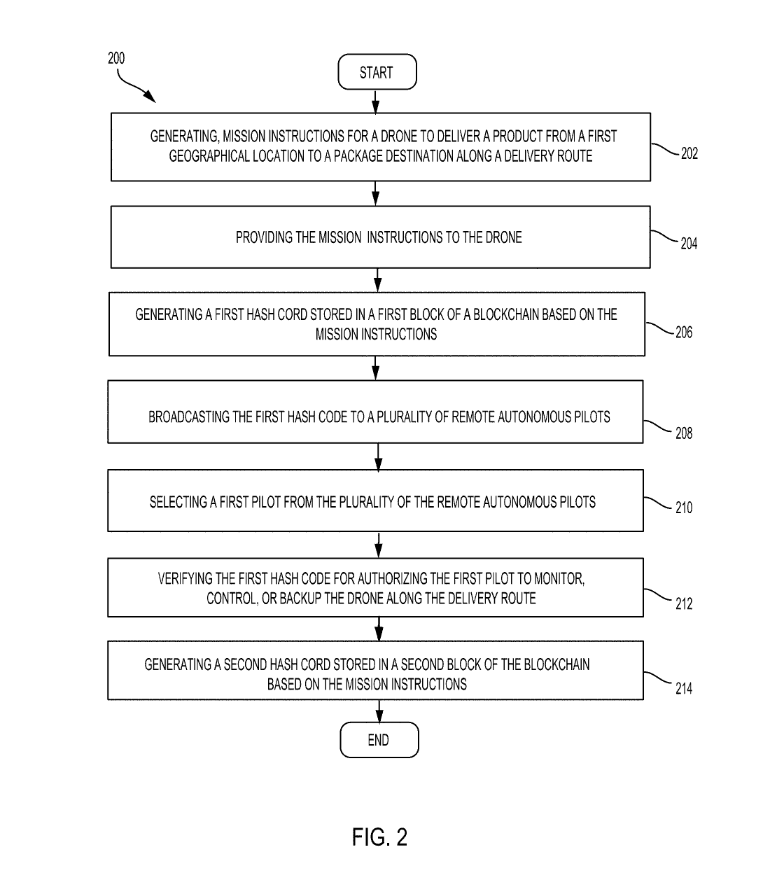

FIG. 2 is a flowchart diagram illustrating an example process 200 for establishing a daisy-chain connection with autonomous remote pilots to command, control, and backup a drone mission and providing a visual line of sight along a drone flight route. The process 200 may be implemented in the above described systems and may include the following steps. Steps may be omitted, ordered or combined depending on the operations being performed.

In step 202, a mission instruction for a drone may be generated by a central serve 112 or other computing devices on the platform 110 for a drone 130 to navigate from an original location (e.g., D1) to a destination 120 along a flight route 122. The mission instruction may be generated in response to a user's request for a particular drone service, such as delivering an ordered product, conducting a field investigation, etc.

In step 204, the drone may receive the mission instruction from the central server 112 via the network and automatically navigate to the destination 120 designated by the user.

In step 206, a first verification code may be generated based on a pre-defined criteria by the central server 112. The generated first verification code may be updated in the mission instruction. For example, the first verification code may be stored in a first block of a blockchain based on the mission instructions.

In step 208, the first verification code with the mission instruction may be broadcasted via the network to a plurality of remote pilots. Each of the plurality of remote pilots 140[1]-[N] may be identified by its identification number or its device address in the system. The plurality of the remote pilots may receive the first verification code with the mission instruction and broadcast their availability with its identification number or its device address in real-time via the network.

In step 210, a first pilot 140[1] may be automatically selected by the central server 112 or by the drone 130 from the plurality of the autonomous remote pilots. The selection may be based on the location of the drone 130 and the availability of the remote pilots such that a visual line of sight may be maintained along a drone flight route.

In step 212, the central sever 112 may select and verify the first verification code provided by the first pilot 140[1] for authorizing the first pilot 140[1] to monitor, control, or backup the drone 130 along the flight route 122.

In step 214, the central sever 112 may generate a second verification code and update the mission instruction. The central sever 112 may continuously update the mission instructions while generating the first verification code and the second verification code; broadcasting the second verification code to the plurality of remote autonomous pilots; selecting a second remote pilot from the plurality of the remote pilots to monitor, control, or backup the drone along the flight route. The central server 112 may verify the second verification code provided by the second remote pilot for authorizing the second remote pilot to monitor, control, or backup the drone along the flight route 122 such that a visual line of sight may be maintained along a drone flight route. For example, the system may communicatively control a first pilot 140[1] to a second pilot 140[2] and facilitate the transfer of control from the first pilot 140[1] to the second pilot 140[2], and so on until the drone 130 safely arrives at the destination 120 or node D6, as shown in FIG. 1. Thus, the plurality of the remote pilots are established along the flight route and are configured to operate at least one drone remotely and visually so that the system can maintain autonomous VLOS until the drone flight mission is completed.

In some example embodiments, the first pilot may be configured to monitor, control, or backup ground operations associated with the drone delivery while the ground operations comprise a movement of the product package with a movement of the drone. The remote pilot may monitor, control, or backup a product delivery including automatically loading the product to the drone and launching the drone from a ground station based on the mission instruction. These processes associated with the drone may be seen by the plurality of the remote pilots. In one embodiment, the remote pilots may also interface with store operations to merge the movement of product with the availability and movement of delivery drones.

In some example embodiments, the system may determine when the drone safely arrives at the mission destination, such as delivering the package at the package destination.

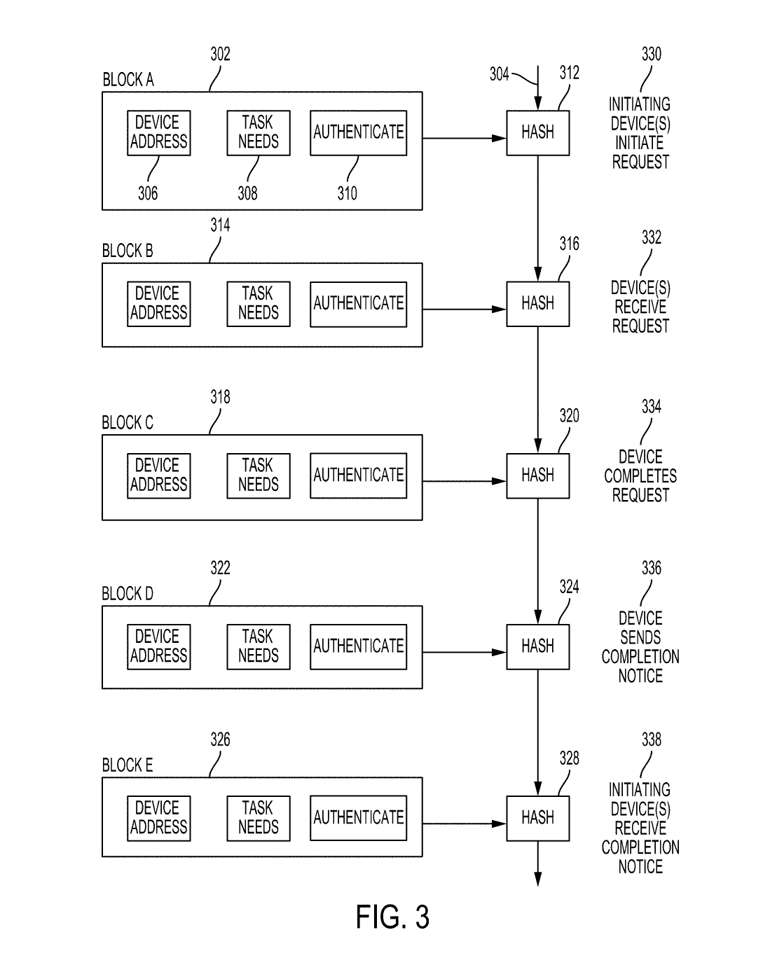

FIG. 3 illustrates an exemplary workflow associated with blockchain based on interactions between various computing devices. A blockchain is a distributed digital ledger which is communicated electronically between devices. Each transaction recorded within the digital ledger is a block which can be hashed or otherwise encrypted. As new transactions are added to the digital ledger, each transaction's veracity can be tested against the previous ledger stored by the devices, and can, in some configurations, require confirmation from a defined percentage (usually 50%) of the devices to be added to the blockchain.

In the case of distributing computational requests, and reallocating computational tasks among the various devices based on the responses to the requests, the blockchain can take the form illustrated in FIG. 3. In this example, there is a blockchain 304 which has been distributed among multiple devices. One of the devices, an initiating device, determines that distributing a computation among other devices would be a better outcome, and proceeds to initiate a request 330. Initiation of the request, in this example, includes generating a block (Block A 302). In this example, each block added to the block chain contains the device address 306 or identification of the device making the request, responding to the request, or otherwise communicating with the remaining devices in the group of devices. The blocks can contain the task needs 308, which can include the specific request for resources or actions, responses to requests, completion notifications, etc. In addition, the blocks can contain an authentication 310 portion, where the device can approve or authenticate the validity of other transactions and/or provide authority for the present transaction.

As the device generates the block 302 for the initial request, the block 302 is hashed 312 into the previous blockchain 304, resulting in an updated blockchain which is distributed among the devices in the group. The other devices receive the updated blockchain containing the request 332 and generate blocks 314 in response to the request. These responses are hashed 316 into the blockchain. In some scenarios, an additional block could be generated by the initiating device based on the response blocks 314, indicating what action will be taken based on the responses received.

When a device completes the request 334, that device generates a block 318 which is subsequently hashed 320 and added to the blockchain. If a completion notice 336 needs to be generated and sent to the initiating device, the completing device can generate another block 322, which can similarly be hashed 324 and added to the blockchain. Once the initiating device receives the completion notice 338, it may generate a notification indicating the request has been fulfilled, which would similarly require a block 326 to be generated and hashed 328 into the blockchain.

Referring to FIG. 3, the term “devices” associated with the blockchain is referred to a plurality of remote pilots. The term “TASK NEEDS’ associated with the blockchain is referred to a drone flight mission. The term “Hash’ associated with the blockchain is referred to a verification code for authorizing a remote pilot 140 to monitor, control, or backup the drone 130 along the flight route 122. The process of 200 may be utilized for various computing devices to implement an autonomous remote pilot control system for establishing a daisy-chain connection with various computing devices and provide a visual line of sight along a flight route. For example, a pre-defined criteria associated with the block chain may be configured to record the mission instructions and the drone parameters. The pre-defined criteria associated with the block chain may be configured to issue an authentication and provide a hash code to autonomous remote pilots to transfer a pilot control operation. Various computing devices may be registered in the pilot control system each with a unique identification number and are configured to operate as remote pilots as described above in the process 200.

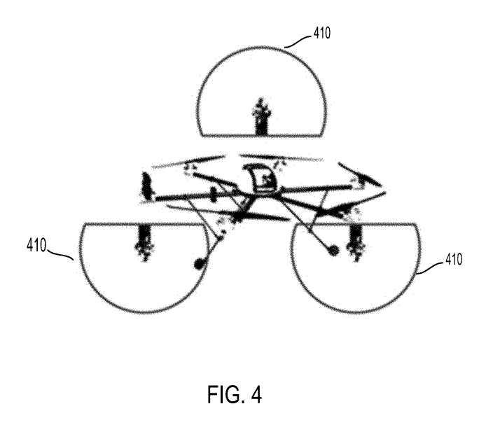

FIG. 4 illustrates an example drone in accordance with some example embodiments. In one embodiment, if the drone becomes detached from the autonomous remote pilot system and does not communicate with the system, it may automatically track and navigate itself to the nearest grid of pilots and to be picked up visually by another remote pilot system. The drone may travel horizontally and also fly higher to the permitted limits in order to be located, or stop where it is until a remote system can detect it. A drone equipped with onboard sensors 410 with 360° dome sensor positioning view may be used to track and detect the drones as they navigate along their flight routes. A process may also involve in simply maintaining drone's course on an air rail (e.g., flight route) or back tracking location, as this may quickly bring the drone into a range of a visual line of sight with another remote pilot in the daisy chain along the flight route.

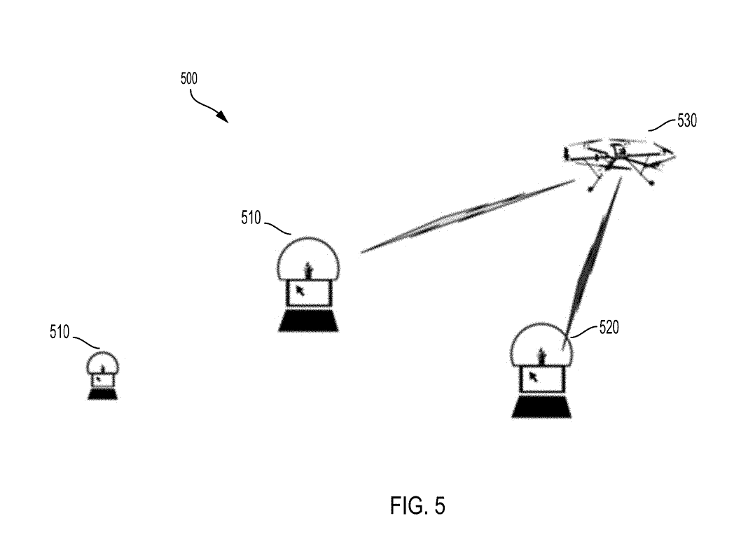

FIG. 5 is a diagram illustrating an example system 500 of autonomous command and control system in accordance with some example embodiments. Referring to FIG. 5, each remote pilot is patched in and may operate a UAV or drone remotely and visually if necessary. The system 500 may include a plurality of autonomous remote pilots 510 and a manual ground control station 520 with pilot in command, and drone 530. The process of 200 may be utilized for various computing devices to implement the system 500. Various computing devices may be registered in the system each with a unique identification number and are configured to operate as remote pilots as described above in the process 200. Thus, the system 500 may be utilized for establishing a daisy-chain connection with various computing devices to provide a visual line of sight along a flight route.

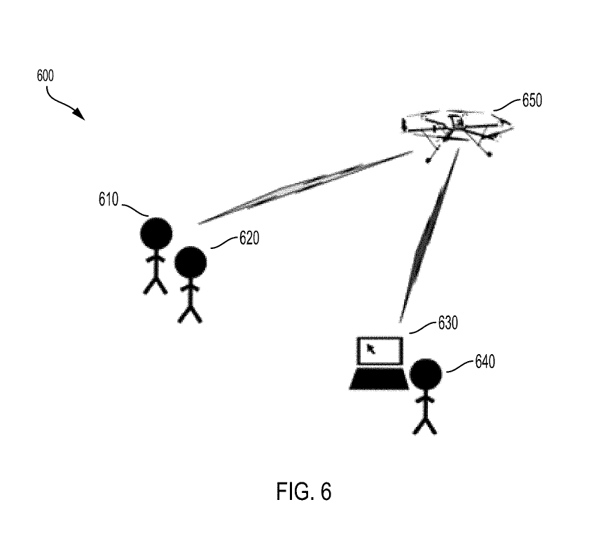

FIG. 6 is a diagram illustrates a manual command and control system 600 in accordance with some example embodiments. The system may include a visual observer 610, human pilot in command 620, manual ground control station 630, operating crewmember 640, and drone 650. Referring to FIG. 6, a human pilot 620 may take control of the drone if necessary or take control after the remote pilot is provided with the necessary time for the human pilot 620 to become oriented. The manual ground control station 630 may operate as a remote pilot or visual observer with the added benefit of enhanced situational awareness incorporated with onboard sensors. When needed, a crewmember 640 may have an ability to be logged in to the computing system of the drone via manual ground control station 630 to remotely control the drone 650. The process of 200 may be utilized for various computing devices to implement the system 600. Various computing devices may be registered in the system each with a unique identification number and are configured to operate as remote pilots as described above in the process 200. Thus, the system 600 may be utilized for establishing a daisy-chain connection with various computing devices to provide a visual line of sight along a flight route.

In some example embodiments, a human pilot on site may be selected or assessed based upon confidence level, certification, scheduled time window, history, etc.

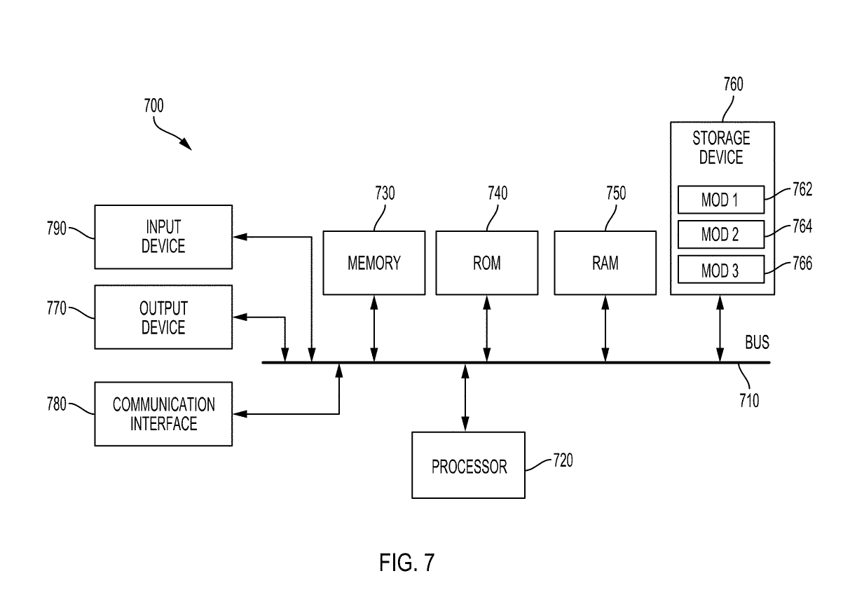

FIG. 7 illustrates an example computer system 700 which may be used to implement embodiments as disclosed herein. The computing system 700 may be a server, a personal computer (PC), or another type of computing device.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

What is claims is:

1. A computer-implemented method for establishing a connection with a plurality of remote pilots to provide a visual line of sight along a flight route, comprising:
under control of a computing device configured with executable instructions:
generating a mission instruction for a drone to navigate from an original location to a destination along the flight route;
instructing the drone with the mission instruction to navigate to the destination;
generating, based on a pre-defined criteria, a first verification code based on the mission instruction;
broadcasting the first verification code with the mission instruction to a plurality of remote pilots;
selecting a first pilot from the plurality of the remote pilots;
verifying the first verification code provided by the first pilot to authorize the first pilot to monitor, control, or backup the drone along the flight route; and
generating a second verification code based on the mission instruction.

2. The computer-implemented method of claim 1, further comprises:
updating the mission instruction in real-time while generating the first verification code and the second verification code;
broadcasting the mission instruction with the second verification code to the plurality of the remote pilots;
selecting a second pilot from the plurality of the remote pilots; and
verifying the second verification code provided by the second pilot to authorize the second pilot to monitor, control, or backup the drone along the flight route.

3. The computer-implemented method of claim 1, wherein each of the plurality of remote pilots is identified by a unique identification number.

4. The computer-implemented method of claim 1, wherein each remote pilot is configured to monitor operations of the drone.

5. The computer-implemented method of claim 1, further comprises determining the drone safely arrives at the destination.

6. The computer-implemented method of claim 1, wherein the mission instruction comprise the original location, the destination, operational parameters of the drone, flight route, weather condition.

7. The computer-implemented method of claim 6, wherein the operational parameters of the drone comprise GPS information, flight heights, flight speeds, flight route, battery information, direction, and air speed.

8. The computer-implemented method of claim 1, wherein each of the plurality of the remote pilots are established along the flight route and is configured to operate at least one drone remotely and visually.

9. The computer-implemented method of claim 1, wherein the first verification code and the second verification code are generated as block chain hash codes based on the pre-defined criteria, and wherein the block chain hash codes dynamically record the mission instructions and operational parameters of the drone.

10. A system for establishing a connection with a plurality of remote pilots to provide a visual line of sight along a flight route, comprising:
a plurality of remote pilots;
at least one computer processor; and
a non-transitory computer-readable storage medium having instructions stored which, when executed by the processor, cause the processor to perform operations comprising:
generating a mission instruction for a drone to navigate from an original location to a destination along the flight route;
instructing the drone with the mission instruction to navigate to the destination;
generating, based on a pre-defined criteria, a first verification code based on the mission instruction;
broadcasting the first verification code with the mission instruction to a plurality of remote pilots;
selecting a first pilot from the plurality of the remote pilots;
verifying the first verification code provided by the first pilot to authorize the first pilot to monitor, control, or backup the drone along the flight route; and
generating a second verification code based on the mission instruction.

11. The system of claim 10, wherein the operations further comprise:
updating the mission instruction in real-time while generating the first verification code and the second verification code;
broadcasting the mission instruction with the second verification code to the plurality of the remote pilots;
selecting a second pilot from the plurality of the remote pilots; and
verifying the second verification code provided by the second pilot to authorize the second pilot to monitor, control, or backup the drone along the flight route.

12. The system of claim 10, wherein each of the plurality of remote pilots is identified by a unique identification number.

13. The system of claim 10, wherein the first pilot is configured to monitor operations of the drone.

14. The system of claim 10, wherein the operations further comprise determining the drone safely arrives at the destination.

15. The system of claim 10, wherein the mission instructions comprise the original location, the destination, operational parameters of the drone, flight route, weather condition.

16. The system of claim 15, wherein the operational parameters of the drone comprise GPS information, flight heights, flight speeds, battery information, direction, and air speed.

17. The system of claim 10, wherein each of the plurality of the remote pilots are established along the flight route and is configured to operate at least one drone remotely and visually.

18. The system of claim 10, wherein the first verification code and the second verification code are generated as block chain hash codes based on the pre-defined criteria, and wherein the block chain hash codes dynamically record the mission instructions and operational parameters of the drone.

19. A non-transitory computer-readable storage medium having instructions stored which, when executed by a computing device, cause the computing device to perform operations comprising:
generating a mission instruction for a drone to navigate from an original location to a destination along a flight route;
instructing the drone with the mission instruction to navigate to the destination;
generating, based on a pre-defined criteria, a first verification code based on the mission instruction;
broadcasting the first verification code with the mission instruction to a plurality of remote pilots;
selecting a first pilot from the plurality of the remote pilots;
verifying the first verification code provided by the first pilot to authorize the first pilot to monitor, control, or backup the drone along the flight route; and
generating a second verification code based on the mission instruction.

20. The non-transitory computer-readable storage medium of claim 19, wherein the operations further comprise;
updating the mission instruction in real-time while generating the first verification code and the second verification code;
broadcasting the mission instruction with the second verification code to the plurality of the remote pilots;
selecting a second pilot from the plurality of the remote pilots; and
verifying the second verification code provided by the second pilot to authorize the second pilot to monitor, control, or backup the drone along the flight route.
